(19) United States
(12) Patent Application Publication
(10) Pub. No.: US 2009/0113797 A1
(43) Pub. Date: May 7, 2009

(54) Method and system of controlling a door drive

(76) Inventor: Michael Hoermann, Halle/Westphalia (DE)

Correspondence Address: DILWORTH & BARRESE, LLP, 333 EARLE OVINGTON BLVD., SUITE 702, UNIONDALE, NY, 11553, US

(21) Appl. No.: 12/286,937

(22) Filed: Oct. 3, 2008

(30) Foreign Application Priority Data
Oct. 5, 2007 (DE) 10 2007 047 769.6
Jan. 4, 2008 (DE) 10 2008 003 186.0

(51) Int. Cl. E05F 15/10; E06B 3/70

(52) U.S. Cl. 49/26; 49/506

(57) ABSTRACT

The present invention relates to a method of controlling a door drive, in particular of a roller door, wherein a capacitive sensor is used for the automatic recognition of obstructions in the region of the door closing path, wherein the recognition of obstructions on the closing of the door takes place by a comparison of the then current change in the capacity of the capacitive sensor with respect to a variable with a reference value or a reference curve.

The invention furthermore includes a corresponding system of controlling a door drive.

The present invention relates to a method and to a system of controlling a door drive, in particular of a high-speed door, in which a capacitive sensor is used for the automatic recognition of obstructions in the region of the door closing path of the door.

Methods are already known from the prior art in this respect in which obstructions are automatically recognized and the door is thereupon stopped automatically so that a jamming protection is present.

Light barriers and light curtains for the detection of persons in the door closing region are, for example, frequently installed in the door closing region at self-closing elevator doors, revolving doors or leaf doors and their output signal effects an aborting of the closing procedure and a new opening. Their installation takes place e.g. in the door plane, with light discharge openings and reflection prisms being arranged in the door edge region subject to high mechanical stress. Mechanical damage, maladjustment and the risk of contamination limit their reliability.

In the specification DE 4424510, a safety edge assembly for a movable closure is described. Under the influence of force, an electrically conductive mounting rail contacts a deformable member and presses it into a second position. The necessity of an influence of force with the risk of a non-timely reaction of the closing mechanism is disadvantageous in this context. A high installation effort and the risk of permanent mechanical damage limit the reliability.

It is the object of the present invention to provide an improved method and system of controlling a door drive which enables a high sensor sensitivity and a reliable jamming protection and which eliminates disturbing influences to the largest possible extent.

In accordance with the invention, this object is solved by a method in accordance with claim 1. In the method in accordance with the invention of controlling a door drive, a capacitive sensor is used for the automatic recognition of obstacles in the region of the door closing path of the door. In accordance with the invention, in this respect, the recognition of obstructions on the closing of the door takes place by a comparison of the then current change in the capacity of the capacitive sensor with respect to a variable with a reference value or with a reference curve.

Since the change in the capacity with respect to a variable is used for the recognition of obstacles, it is possible in accordance with the invention to eliminate the influence of a static capacity C₀ which can vary due to moisture, temperature or contamination as well as due to changing environmental influences and equally to compensate the influence of post capacities and ground capacities. A high sensor sensitivity or a large detection spacing with respect to the obstruction can hereby be achieved. Higher closing speeds at the door can hereby be run and additionally an improved personal protection against jamming can be realized. Shorter door closing times associated with this can enable a rapid traffic flow and reduce temperature change in a hall due to open doors in winter or in summer.

Preferred embodiments of the invention result from the dependent claims following on from the main claim.

The present invention will be shown in more detail in the following with respect to an embodiment shown in the drawing. There are shown

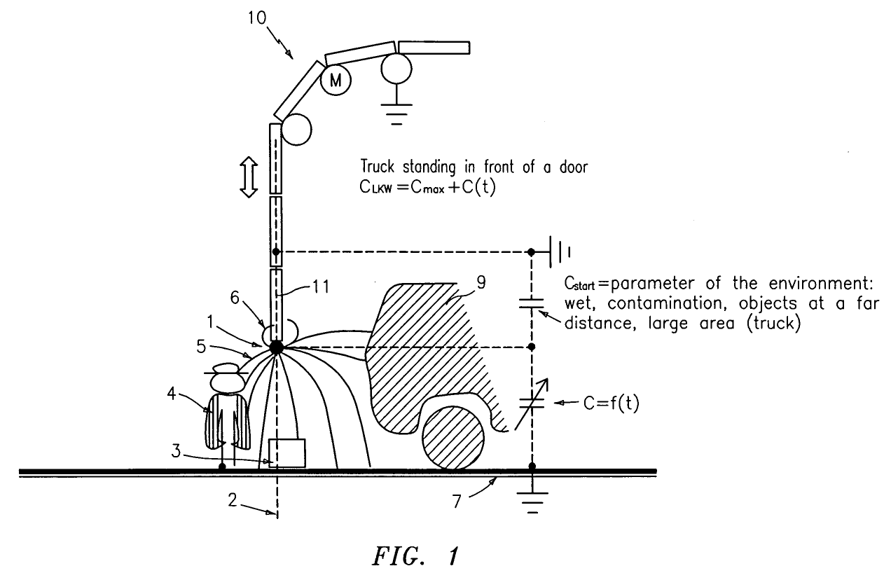

FIG. 1: a schematic diagram of a closing procedure in which obstructions are located in the region of the door closing path; and

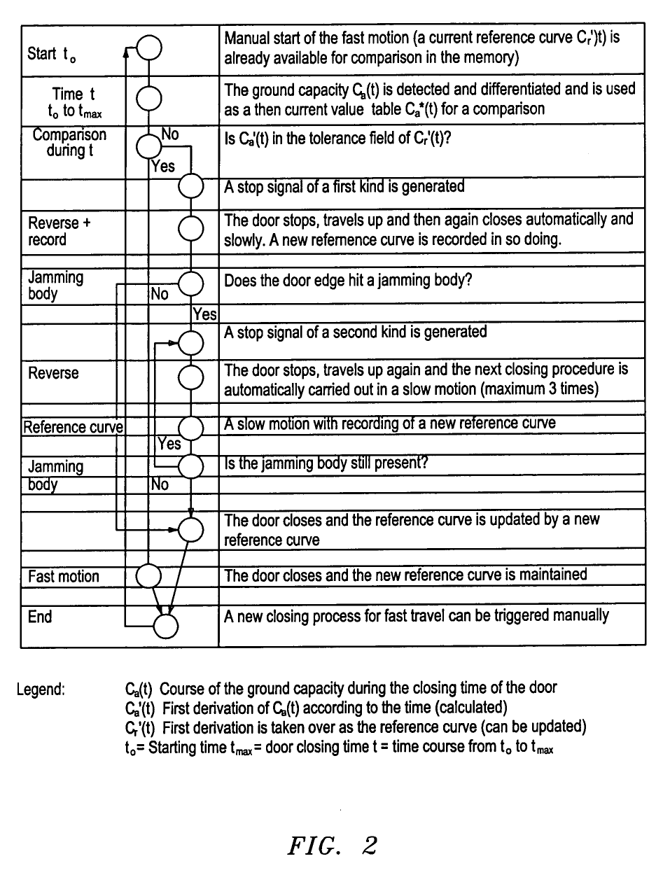

FIG. 2: a flow chart of an embodiment of the method in accordance with the invention.

FIG. 1 now shows in a schematic diagram the closing procedure of a roller door 10 while obstructions are located in the region of the door closing path 2. The door 10 can in this respect be moved upwardly and downwardly via the door drive. The door drive is controlled by the controller in accordance with the invention.

In accordance with the invention, a sensor surface 1 is arranged in insulated fashion at the bottommost lamella 11 of the door leaf and the sensor capacity to the earth potential of the ground of said sensor surface is detected during the closing procedure. The field lines of the capacitive sensor are shown as solid lines in this respect. On the one hand, static field lines 6 toward the earthed lamella result which produce a constant contribution to the capacity during the door motion. Furthermore, the static disturbance capacity is influenced by further parameters of the environment, wet, dirt and also objects at a far spacing. The rear side of a truck 9 is drawn by way of example in this respect which is parked next to the door and likewise influences the course of the field lines with a static component. The static disturbance capacity C₀=Cₛₜₐₜ is drawn at the right as a constant capacitor in the schematic diagram. This capacity is static in this respect in that it substantially does not change during a door closing procedure and is in particular not dependent on the position of the door. The static capacity can, however, change over time due to changed environmental conditions. The total capacity furthermore includes, in addition to this static capacity, a capacity which depends on the position of the sensor surface 1 at the door leaf above the earthed ground 7 and which thus changes during the movement of the door.

To keep the influence of the static capacity as low as possible, it is now in accordance with the invention not the absolute value of the capacity of the sensor which is composed of the static portion and the portion variable on the movement of the door which is used, but rather the change in the capacity during the door movement with respect to a variable, e.g. the time or the travel path of the door. In this respect, the derivation of the capacity e.g. with respect to the time or to the travel path is in particular used to eliminate the influence of the static capacity. Changes in the static disturbance capacity due to changing environmental conditions can no longer have a negative influence on the obstruction recognition due to this elimination of the static capacity so that the system in accordance with the invention permits a substantially improved obstruction recognition.

In this respect, the first derivation of a capacity function is first calculated and stored as a reference curve which henceforth serves as a comparison measure for all the closing procedures later taking place in which an updated first derivation of the capacity function is calculated in the same way and is compared with the reference curve. The reference curve is first generated while no obstructions are located in the region of the door closing path 2 so that the reference curve corresponds to an unobstructed closing procedure.

If now an obstruction, e.g. a person 4 or an obstructing body 3, is located in the region of the door closing path of the door, the then currently calculated derivation of the capacity function hereby changes in comparison with the stored reference curve. In this connection, the permitted degree of deviation can be fixed via a selectable tolerance field. If the then currently determined derivation of the capacity function exceeds this tolerance field, an exceeding signal of a first kind is generated, whereupon the closing procedure is stopped, reversed and continued in a slow motion after a selectable dead time. In this respect, persons have a high dielectricity constant and greatly influence the field between the sensor surface 1 and the ground 7 so that they can be detected very easily.

The closing is then continued in a slow motion after the generation of an exceeding signal until an obstacle approaches the sensor surface up to a minimum spacing and hereby triggers an exceeding signal of a second kind, whereupon the door drive is reversed and the door is fully opened or, if the minimum distance is not fallen below, until the door closes completely in a slow motion. If, in contrast, no stop signal of a second kind is generated, this means that the obstruction does not come much too close to the door leaf plane 2, but is rather located at a safe interval from the door. This is the case in the drawing for the person 4 who is not standing in the door closing path, even though he is already detected by a stop signal of a first kind. The door can close in this case.

If an exceeding signal or stop signal of the first or second kinds is generated, the controller draws an updated reference curve in the following closing procedure in a slow motion. If the door can close in a slow motion without an exceeding signal or stop signal of a second kind being generated, this can be stored. The influence of obstructions which are not located in the region of the door closing path of the door is thus stored in the reference and is taken into account in the next closing procedure. The influence of the truck 9 which is shown in the drawing and which is parked in the vicinity of the door can thus be taken into account in the variable portion of the capacity of the sensor.

It is equally conceivable to provide a plurality of tolerance thresholds so that the door controller in accordance with the invention can react in a stepped manner. When the respective tolerance thresholds are exceeded, exceeding signals of different kinds can be generated to which the door controller then respectively reacts in different manners. The door can thus e.g. first continue to travel more slowly on the exceeding of a first threshold, initially stop on the exceeding of a second threshold and optionally continue to travel even more slowly and only generate the exceeding signal of a second kind on the exceeding of a third threshold, whereupon the door drive is traveled back completely.

The method in accordance with the invention will now be presented in more detail again with reference to the flow diagram shown in FIG. 2. A stop signal or an exceeding signal of a first kind is generated on a fast motion if the then currently calculated first derivation of the capacity according to the time exceeds the preset tolerance field with respect to the reference curve which can be updated. A stop signal or an exceeding signal of a second kind is generated on a slow motion when the closing edge comes even closer to the object. The tolerance range is larger in this connection than for the stop signal of a first kind.

The closing procedure of a door is now usually triggered manually by an operator, whereby the door is closed in a fast motion. On the downward motion of a door, the time is now first set to T₀, e.g. by a mechanical, optical or inductive limit value contact, on an exceeding of a selectable level mark, and the detection of the capacity Cₐ(t) is begun from which C′ₐ(t) is calculated by derivation in accordance with the time. If this is being done for the first time, the curve hereby generated is stored in the memory as a reference curve Cᵣ(t) and is then available as a reference curve for comparison in the subsequent closing procedures.

During the closing procedure, the ground capacity Cₐ(t) is now detected, differentiated and compared as the then current value table Cₐ′(t) with the reference curve Cᵣ′(t). The calculation and the comparison take place in real time, with a check being made whether the then currently detected derivation of the capacity in accordance with the time Cₐ′(t) is disposed in the tolerance field of the stored reference curve Cᵣ′(t). If the then current values are disposed in the tolerance field, the door can close completely in a fast motion, with the stored reference curve being maintained.

If the then currently calculated derivation according to the time in contrast exceeds the tolerance field, a stop signal or an exceeding signal of a first kind is generated.

The door is thereupon stopped, traveled upwardly a specific distance and then automatically moved slowly in the closing direction again. A new reference curve is recorded in this process.

A check is made in this respect whether the door edge is approaching an obstruction. The door thereupon again travels completely upwardly and the next closing procedure is automatically carried out in a slow motion. During the slow motion which now takes place, a new reference curve is in turn recorded which is used for the updating of the stored reference curve if a close body is no longer present. If, in contrast, the body is still present, a stop signal of a second kind is in turn generated and the door is traveled upwardly again. This takes place a maximum of three times.

If, in contrast, the door edge does not approach an obstruction, the door can close in a slow motion and the stored reference curve is updated by the newly recorded reference curve.

If the closing procedure has been successfully concluded without the door edge having come close to the obstruction, the door can again be closed in a fast motion on the next closing procedure.

The method in accordance with the invention, in which in the embodiment the derivation of the capacity in accordance with the time is used for the comparison with a reference curve, permits substantially lower tolerance ranges in this respect and thus a substantially improved sensitivity in comparison with known methods. The security is hereby increased and simultaneously a faster closing procedure of the door is made possible.

1. A method of controlling a door drive, in particular of a roller door, wherein
a capacitive sensor is used for the automatic recognition of obstructions in the region of the door closing path of the door, and
the recognition of obstructions on the closing of the door takes place by a comparison of the then current change in the capacity of the capacitive sensor with respect to a variable with a reference value or with a reference curve.

2. A method in accordance with claim 1, wherein the capacitive sensor has a sensor surface arranged at the door leaf whose capacity to the ground is detected.

3. A method in accordance with claim either of claim 1, wherein the change in the capacity of the capacitive sensor with respect to the variable on a non-obstructed closing of the door is detected and stored for the generation of a reference curve.

4. A method in accordance with claim 1, wherein the variable depends on the time and/or on the travel path of the door.

5. A method in accordance with claim 1, wherein the derivation of the capacity of the capacitive sensor with respect to a variable, in particular to the time or the travel path of the door, is used for the recognition of obstructions.

6. A method in accordance with claim 1, wherein the second derivation of the capacity of the capacitive sensor with respect to a variable, in particular to the time or the travel path of the door, is used for the recognition of obstructions.

7. A method in accordance with claim 1, wherein an exceeding signal is generated when the then current value of the change in the capacity of the capacitive sensor with respect to a variable leaves a tolerance range.

8. A method in accordance with claim 7, the door drive is stopped, traveled back or continued more slowly on the basis of an exceeding signal.

9. A method in accordance with claim 7, wherein the door drive is first traveled back a specific distance and then moves the door in the closing direction again.

10. A method in accordance with claim 9, wherein the repeat closing takes place more slowly than the prior closing and/or the door drive stands still for a specific time between the traveling back and the repeat closing.

11. A method in accordance with claim 1, wherein the change in the capacity of the capacitive sensor with respect to a variable then currently detected during the operation is used for the updating of the reference value or of the reference curve.

12. A method in accordance with claim 1, wherein the door is closed by a fast motion or of a slow motion, in dependence on the comparison of the then current change in the capacity of the capacitive sensor with respect to a variable with a reference value or a reference curve.

13. A method in accordance with claim 1, wherein the detection of the change in the capacity of the capacitive sensor with respect to a variable takes place from a height mark.

14. A method in accordance with claim 16, wherein the height mark is set by a mechanical, optical or inductive limit value contact or it is derived from the data flow generated by the drive unit.

15. A method in accordance with claim 1, wherein the capacitive sensor has a sensor surface which extends along the total lower edge of the door leaf.

16. A method in accordance with claim 1, wherein the capacitive sensor has a sensor surface which is embedded in a sealing lip at the lower edge of the door.

17. A system of controlling a door drive, in particular of a roller door, for the automatic recognition of obstructions in the region of the door closing path of the door having a capacitive sensor and an evaluation unit which detects and evaluates the capacity of the sensor, wherein the evaluation unit calculates the then current change in the capacity of the capacitive sensor with respect to a variable for the recognition of obstructions on the closing of the door and compares it with a reference value or a reference curve.

18. A system in accordance with claim 17, wherein the capacitive sensor has a sensor surface which is arranged at the door leaf and whose capacity to the ground is detected.

19. A system in accordance with claim 17, wherein the capacitive sensor has a sensor surface which extends along the total lower edge of the door leaf.

20. A system in accordance with claim 17, wherein the capacitive sensor has a sensor surface which is embedded in a sealing lip at the lower edge of the door.

21. A system in accordance with claim 17, comprising a memory in which a reference value or a reference curve is stored which is determined from a change of the capacity of the capacitive sensor with respect to a variable calculated by the evaluation unit.

22. (canceled)
